(19) United States
(12) Patent Application Publication
(10) Pub. No.: US 2015/0132463 A1
(43) Pub. Date: May 14, 2015

(54) Reduced-Calorie Partially-Frozen Beverages

(71) Applicant: DR PEPPER/SEVEN UP, INC., PLANO, TX (US)

(72) Inventors: Bharani Ashokan, McKinney, TX (US); Stacey K. Walton, Frisco, TX (US); Gino Olcese, Allen, TX (US); Paul R. Zanno, McKinney, TX (US); Adrian M. Sepcic, Frisco, TX (US)

(21) Appl. No.: 14/075,719

(22) Filed: Nov. 8, 2013

(51) Int. Cl. A23L 2/60; C12G 3/00

(52) U.S. Cl. CPC A23L 2/60; C12G 3/00
USPC 426/548; 426/590; 426/592

(57) ABSTRACT

The present disclosure provides for a reduced-calorie partially-frozen beverage, concentrate syrup, mix and a method for making a reduced-calorie partially-frozen beverage. The freezing point of the partially-frozen beverage is depressed through the use of an L-sugar, such as, for example, L-hexose monosaccharide alone or in combination with other freezing point depressants. In a particular embodiment, L-glucose is added to a reduced-calorie partially-frozen beverage in a range between about 0.1% to about 10% by weight of the finished beverage.

### FIELD

The present disclosure relates to reduced-calorie and zero-calorie partially-frozen beverages and a method of making the same through the use of L-sugars, such as L-hexose monosaccharide. In a preferred embodiment, the present disclosure is directed to a reduced-calorie or zero-calorie partially-frozen beverage that comprises L-glucose. In this particular embodiment, the L-glucose serves the dual function of a reduced-calorie sweetener and a freezing point depressant.

### BACKGROUND

Full-calorie partially-frozen beverages, such as frozen carbonated beverages (“FCBs”), are known in the art and have been consumed for several years.

U.S. Pat. No. 7,278,276 to Boyer et al., which is herein fully incorporated by reference, discloses a beverage apparatus for preparing and dispensing a partially-frozen beverage and, in particular, a FCB.

FCBs are commonly produced via dispensing devices that freeze a mixture of ingredients including sugar, flavor, water, and carbon dioxide in a cylindrical mixing chamber. The mixture freezes on the inner surface of the mixing chamber, which is surrounded by a helical coil through which a refrigerant passes. A rotating shaft is disposed inside the cylindrical chamber which has a plurality of outwardly-projecting blades that scrape the mixture off the inside wall of the mixing chamber. Once the carbonated beverage is in the desired partially-frozen state, the product is dispensed from the chamber through a product valve.

The temperature and viscosity of the beverage within the mixing chamber are maintained by a control system that controls the refrigeration system. Product quality is controlled through the balance of ingredients as well as pressures and temperatures within the chamber. The chemical properties of FCBs also play an important role in the normal functioning of FCB dispensing devices and the quality and consistency of the FCB products. If the FCB is too cold, it will freeze causing the rotating shaft to cease within the mixing chamber and render the dispenser inoperative. If the FCB is too warm, the FCB will not attain the desired partially-frozen consistency.

Current FCB products are generally limited to full-calorie FCBs. Full-calorie products contain common sugars, such as sucrose or high fructose corn syrup (“HFCS”), which are used as sweeteners at concentrations of about 10% by weight of the finished beverage. These sugars play an important part in the freezing point depression of FCBs. Under normal operating conditions of FCB machines, the addition of sugar depresses the freezing point of the product, thereby making it dispensable in a partially-frozen or slush-like state.

By contrast, a diet or zero-calorie beverage contains little-to-no common sugars, such as sucrose or HFCS, and thus lacks a sufficient freezing point depressant. Without a freezing point depressant and, therefore, a modified freezing point, the sugarless beverage freezes into a block of ice within the dispensing machine soon after the temperature drops below 32° F.

The challenge associated with creating diet and low-calorie partially-frozen beverages is one that the beverage industry has been attempting to overcome for several decades. For example, U.S. Pat. No. 5,069,924 to Baccus, Jr., which is herein fully incorporated by reference, discloses a low-calorie slush beverage with microcrystalline cellulose to lower the freezing point of the low-calorie beverage.

Degrees Brix (symbol ° Bx) is a measure of the sugar content of an aqueous solution. One degree Brix is equal to 1 gram of sucrose in 100 grams of solution and represents the strength of the solution as percentage by weight. If the solution contains dissolved solids other than pure sucrose, then the ° Bx only approximates the dissolved solid content.

Typical full-calorie FCBs measure approximately 12-14° Bx and the sugar allows the FCB to freeze at around 24-28° F. Without the sugar, the freezing characteristics of the FCB would exhibit that of pure water and would freeze just below 32° F.

As stated above, current full-calorie partially-frozen beverages have a lower finished product temperature of approximately 24° F. to 30° F. As the full-calorie FCB temperature drops below 32° F., the freezing process becomes easily controllable by the FCB dispensing machine. Diet or sugarless FCBs, on the other hand, have a higher freezing point and the freezing process is less gradual and too difficult to control for conventional FCB machines.

The freezing point of a water-based beverage depends, in-part, on the number of soluble molecules present. Calorie-free soluble ingredients, such as salts or acids, could be added to sugarless beverage mixes to depress the freezing point, thus allowing slush to be formed. Although non-caloric, the addition of too much soluble salts and acids result in a salty or sour beverage that renders the beverage undesirable for consumption.

As another alternative, instead of adding acids or salts, the amount of non-caloric sweeteners (e.g., aspartame, saccharin, stevia glycosides, or sucralose) may be added at a greater concentration to sufficiently depress the freezing point. The problem with this solution, however, is that due to the potency of these sweeteners, the taste and quality of the resulting beverage is also unacceptably poor.

The present disclosure overcomes the problems associated with the prior art through the use of L-sugars, including L-pentose monosaccharide or L-hexose monosaccharide, and, more particularly, L-glucose, as a freezing point depressant.

U.S. Pat. No. 4,262,032 to Levin, which is herein fully incorporated by reference, discloses using L-hexose monosaccharide as a sweetening agent in various foods.

U.S. Pat. No. 5,229,573 to Tarka, Jr. et al., which is herein fully incorporated by reference, discloses using L-sugar, such as L-glucose, as a laxative.

U.S. Pat. No. 8,470,983 to Delaney et al., which is herein fully incorporated by reference, discloses using L-sugar, such as L-glucose, as a colon cleansing agent.

Unlike common sugars, L-hexose monosaccharides are either not metabolized by the body or are metabolized to such a small extent that they provide for a reduced-calorie alternative to other reduced-calorie or calorie-free sweeteners.

It has been discovered that, unlike other reduced-calorie sweeteners, L-hexose monosaccharide and L-pentose monosaccharide adequately depress the freezing point of water to enable the partially-frozen beverage to achieve the desired slushy state without unacceptable alterations to the taste and quality of the beverage.

More particularly, this disclosure provides for zero and reduced-calorie partially-frozen beverages that have similar texture and sweetness as full-calorie partially-frozen beverages. The beverage of the current disclosure, however, will not have the high calorie content that currently exists with full-calorie partially-frozen beverages, such as FCBs.

The present disclosure overcomes the deficiencies associated with the production of reduced-calorie partially-frozen beverages through the use of L-hexose monosaccharide and/or L-pentose monosaccharide as a freezing point depressant. L-hexose monosaccharide and/or L-pentose monosaccharide may also be added in conjunction with caloric and non-caloric sweeteners, salts, acids, sugar alcohols (e.g., erythritol), and betaine to produce reduced-calorie frozen beverages with optimal taste and consistency characteristics.

### SUMMARY

In one particular embodiment, a reduced-calorie partially-frozen beverage comprising water, flavoring, and L-hexose monosaccharide or L-pentose monosaccharide is provided. In another particular embodiment, at least about 0.17 moles per kg of water of L-glucose is added. In yet other particular embodiments, the beverage is a frozen carbonated beverage.

In some of the embodiments, high-intensity sweeteners may also be added to the reduced-calorie partially-frozen beverage to optimize and account for the loss of sweetness resulting from the reduction of caloric sweeteners. Examples of high-intensity sweeteners include aspartame, saccharin, acesulfame-K, stevia glycosides, minor constituents of stevia glycosides, cyclamate, Lo Han Guo, and sucralose.

In yet another particular embodiment, in addition to L-hexose monosaccharide or L-pentose monosaccharide, a secondary freezing point depressant is added to the reduced-calorie partially-frozen beverage. In some of these embodiments, the secondary freezing point depressant may be a caloric sweetener, betaine, D-tagatose, a sugar alcohol (such as and in particular erythritol), ethyl alcohol, mineral salts, acidulants, or any combination of these.

Other embodiments of this disclosure include reduced-calorie beverage syrups and mixes for use in a partially-frozen beverage dispensing machine. In these particular embodiments, L-glucose is added in sufficient quantity to depress the freezing point of the resultant partially-frozen beverage

In yet other embodiments, a pre-packaged, reduced-calorie, partially-frozen beverage is provided, which comprises L-glucose and is packaged in a flexible pouch for storage in a consumer's freezer, for example, until ready for consumption.

### BRIEF DESCRIPTION OF THE DRAWINGS

FIG. 1 is a graph showing the freezing characteristics of sucrose, HFCS 42, L-glucose, erythritol, and betaine in accordance with this disclosure.

FIG. 2 is a graph showing an increase in solute concentration (in millimoles of solute per kilogram of solvent water) upon addition of betaine, erythritol, HFCS-42, sucrose, and L-glucose vs. the component's weight present.

### DESCRIPTION OF THE PREFERRED EMBODIMENTS

This disclosure is directed to reduced-calorie, partially-frozen beverages that utilize L-sugars as a freezing-point depressant and sweetener.

An L-sugar is defined as a monosaccharide in which the hydroxyl group at the lowest chiral carbon atom in a Fischer projection structure is on the left. Examples of L-sugars include L-aldoses, L-ketoses, L-aldopentoses, L-aldohexoses, L-ketopentoses, and L-ketohexoses. L-aldopentoses include L-ribose, L-xylose, and L-lyxose. L-aldohexoses include L-allose, L-altrose, L-glucose, L-gulose, L-idose, L-galactose, and L-talose. L-ketopentoses include L-ribulose and L-xylulose. L-ketohexoses include L-fructose, L-psicose, L-sorbose and L-tagatose.

In a preferred embodiment, L-glucose, L-allose, L-fructose, L-gulose, L-galactose, L-altrose, L-idose, L-talose, L-tagatose, and L-psicose, which are L-hexose monosaccharides, may be used in accordance with this disclosure. In another preferred embodiment, L-glucose is used.

In other embodiments of this disclosure, L-pentose monosaccharide may also be used as a sweetener and primary freezing point depressant in a partially-frozen beverage. Examples of L-pentose monosaccharide include L-arabinose, L-lyxose, L-ribose, L-xylose, L-iribulose, and L-xylulose.

The partially-frozen beverage is dispensed or served in a “slushy” condition or otherwise includes at least some ice crystals. As used herein, the terms “partially-frozen,” “semi-frozen,” “slushy,” “slush,” “slushy-like,” and “slush-like” are synonymous. FCBs, smoothies, and slushes are only some of the examples of partially-frozen beverages.

In a preferred embodiment of this disclosure, the partially-frozen beverages comprises a caloric content that is 50% that of a full-calorie equivalent, or less than 60 calories per 8 ounce serving. In yet another embodiment, the partially-frozen beverage has near-zero calories, or less than 5 calories per 8 ounce serving.

As used herein, high fructose corn syrup (“HFCS”) consists of water and D-fructose and D-glucose. As mentioned earlier, D-fructose is commonly referred to simply as fructose and D-glucose is commonly referred to simply as glucose. HFCS-42, which is primarily used in soft-drinks, is a syrup that comprises about 55% fructose and 42% glucose. HFCS-42, which is primarily used in beverages, processed foods, cereals, and baked goods, is a syrup that comprises approximately 42% fructose and 58% glucose. HFCS-90, likewise, is a syrup that comprises approximately 90% fructose and 10% glucose, and is used for specialty applications.

The present disclosure also provides for reduced-calorie beverage syrups and mixes, some of which may be used with a conventional FCB dispensing machine.

Syrups or mixes may be liquid or may be in the form of a powder or other solid. A syrup or mix may or may not be in the form of a concentrate. Beverage syrup and mixes according to the present disclosure includes L-glucose in a concentration sufficient to depress the freezing point of any resulting partially-frozen beverage.

Although several embodiments of this disclosure envision the partially-frozen beverage dispensed from a machine, such as a conventional FCB machine, the reader should appreciate that the partially-frozen beverage may be pre-packaged for retail sale in a grocery store, for example. In this particular embodiment, the partially-frozen beverage is packaged in a container, such as a disposable flexible pouch, and stored in the consumer's freezer until ready for consumption. The presence of L-hexose monosaccharide and/or L-pentose monosaccharide and any secondary freezing point depressants will depress the freezing point to enable the formation of a desirable slush when removed from the freezer.

As disclosed in U.S. Pat. No. 4,262,032 to Levin, L-hexose monosaccharides are sweet, soluble in water, and stable in aqueous solutions.

The term L-hexose monosaccharides as used herein is used within the meaning of the standard terminology of carbohydrate chemists. Thus, for example, one particularly effective sweetening agent according to this disclosure is L-glucose, which is a stereoisomer of the sweetening agent D-glucose. The D and L prefixes are used to denote the configuration of the hexose structure. This may be further exemplified by reference to the following structural formulas:

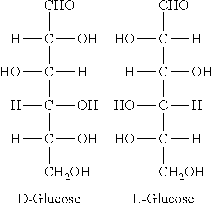 [SMILES: O=CC(O)C(O)C(O)C(O)CO ; O=CC(O)C(O)C(O)C(O)CO]

As may be ascertained from these formulas, these two compounds are mirror images of one another. The prefixes of D- and L- are not to be confused with d- and l-, which are used to denote the direction of optical rotation, i.e., d(dextro-) or l(levo-).

D-glucose is the common form of glucose and reference to glucose without a prefix is used to denote D-glucose. Similarly, D-fructose is the common form of fructose and reference to fructose without a prefix is used to denote D-fructose.

As is common in the art, the term hexose is inclusive of those six carbon sugars or monosaccharides, wherein the carbonyl group is either in the aldehyde form (aldoses) or the keto form (ketoses) and monosaccharide refers to the simple or uncombined sugar. Typical examples of these aldoses or aldohexoses are L-talose, L-galactose, and L-allose, while typical examples of these ketoses or ketohexoses are L-tagatose and L-psicose.

Beverage syrups for use according to one embodiment of the present disclosure utilize one or more of these L-hexose monosaccharides as a freezing point depressant. As discussed above, these L-hexose monosaccharides may be L-glucose, L-allose, L-fructose, L-gulose, L-galactose, L-altrose, L-idose, L-talose, L-tagatose, and L-psicose. In a preferred embodiment, L-glucose is used as the freezing point depressant.

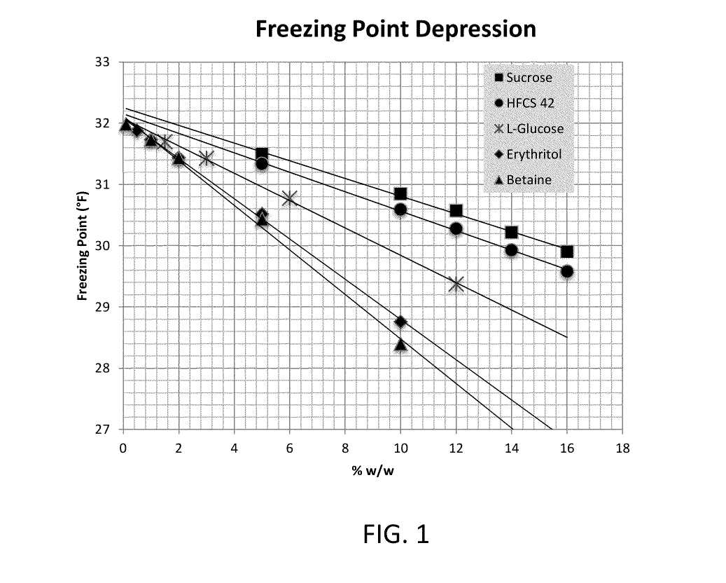

As depicted in FIG. 1, sucrose, HFCS 42, erythritol, betaine, and L-glucose depresses the freezing point when dissolved in water. As can be seen, the amount of freezing point depression is directly proportional to the concentration of sucrose, HFCS 42, erythritol, betaine, and L-glucose dissolved.

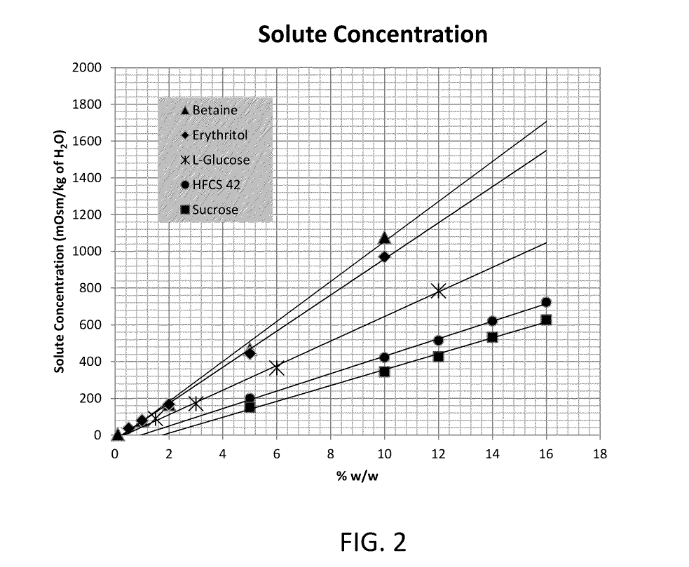

As depicted in FIG. 2, the addition of betaine, erythritol, HFCS (and HFCS-42, in particular), sucrose, and L-glucose increase the particle density of the partially-frozen beverage when added.

In accordance with one embodiment of this particular disclosure, anywhere between about 0.1% to about 20% of the finished beverage weight of L-glucose is added. In a preferred embodiment, at least about 3% to about 10% of L-glucose is added. As explained in more detail in the following EXAMPLES, the freezing point depression is proportional to the concentration of freezing point depressants in the beverage.

In the particular embodiment of Example 1, the zero-calorie partially-frozen beverage comprises L-glucose at a molal level of about 0.35 moles per kilogram of water. At this molal concentration, L-glucose provides for sufficient freezing point depression for the production of a near-zero calorie partially-frozen beverage. In this embodiment, the full-calorie FCB equivalent contained sucrose in a concentration of 12% by weight of finished beverage. In the reduced-calorie version, the sucrose was completely removed and replaced with L-glucose.

In the particular embodiment of Example 2, the reduced-calorie partially-frozen beverage comprises L-glucose at a molal level of about 0.17 moles per kilogram of water and sucrose at a molal level of about 0.17 moles per kilogram of water. The reduced-calorie partially-frozen beverage of this example comprises 50% of the calories of an equivalent full-calorie partially-frozen beverage, which contains 12% by weight sucrose. At these molal concentrations, L-glucose and sucrose both provide sufficient freezing point depression for the production of a 50%-reduced-calorie partially-frozen beverage.

In the embodiment of Example 3, a full-calorie FCB with 10% D-glucose by weight of finished beverage is converted to a zero-calorie (or near-zero calorie) FCB. In this example, D-glucose is replaced with L-glucose at a molal concentration of 0.555 moles per kg of water. In this embodiment, the freezing point is sufficiently depressed to permit dispensing in a slushy-state through a conventional FCB machine. At this molal concentration, the freezing point of the FCB is depressed by about 2° F. as a result of the L-glucose and as further shown in FIG. 1.

In the embodiment of Example 4, a full-calorie FCB with 10% D-glucose by weight of finished beverage is converted to a reduced-calorie FCB by replacing one-half of the D-glucose with L-glucose. In this reduced-calorie equivalent, the molal concentration of L-glucose is about 0.27 moles per kg of water. In this embodiment, the freezing point is sufficiently depressed to permit dispensing in a slushy-state through a conventional FCB machine. At this molal concentration, the freezing point of the FCB is depressed by about 2° F. as a result of the L-glucose and D-glucose.

In the embodiment of Example 5, a full-calorie FCB with 10% D-glucose by weight of finished beverage is converted to a reduced-calorie FCB by replacing the D-glucose with erythritol and L-glucose. In this reduced-calorie equivalent, 3.5% by weight erythritol and 4.6% by weight L-glucose are added to replace the 10% by weight D-glucose. In this embodiment, the freezing point is sufficiently depressed to permit dispensing in a slushy-state through a conventional FCB machine. At this molal concentration, the freezing point of the FCB is depressed by about 2° F. as a result of the L-glucose and erythritol.

In the embodiment of Example 6, a full-calorie FCB with 10% D-glucose by weight of finished beverage is converted to a reduced-calorie FCB by replacing the D-glucose with erythritol, D-tagatose, and L-glucose. In this reduced-calorie equivalent, the D-glucose is replaced with 1.0% by weight D-tagatose, 3.5% by weight erythritol, and 3.7% by weight L-glucose to create an equivalent reduced-calorie FCB. In this embodiment, the freezing point is sufficiently depressed to permit dispensing in a slushy-state through a conventional FCB machine. At this molal concentration, the freezing point of the FCB is depressed by about 2° F. as a result of the L-glucose, D-tagatose, and erythritol.

In addition to L-sugar, such as hexose monosaccharide and/or L-pentose monosaccharide, which are the primary freezing point depressants of this disclosure, the present disclosure also contemplates using secondary freezing point depressants, including caloric and non-caloric ingredients, to supplement the freezing point depression provided by the L-hexose monosaccharide and/or L-pentose monosaccharide.

As for sugar-based secondary freezing point depressants, preferred embodiments of the present disclosure include D-fructose, D-glucose, sucrose, isomerized sugars such as high fructose corn syrup (e.g., HFCS-55, HFCS-42, or HFCS-90), and other carbohydrate sugars. When full-calorie sugars are used, the reader will appreciate that the resulting beverage will have at least some caloric content.

As for other non-caloric secondary freezing point depressants, preferred embodiments of the present disclosure include sugar alcohols, such as erythritol, sorbitol, mannitol, maltitol, and xylitol. In some embodiments, sugar alcohols may be included at up to about 3.5% of the weight of the finished beverage. In yet other embodiments, a sugar alcohol may be included at about 0.1% to about 0.25%, or about 0.20% to about 0.5%, or about 0.4% to about 0.8%, or about 0.6% to about 1.0%, or about 0.8% to about 1.5%, or about 1.5% to about 3.5%.

According to one embodiment of the present disclosure, erythritol is also used as a secondary freezing point depressant along with L-glucose. When erythritol is consumed at moderate levels, it is mostly absorbed into the bloodstream from the small intestine and subsequently excreted in the urine unchanged. Erythritol provides minimal caloric contribution upon consumption and may, in some embodiments, be included in an amount up to about 3.5% by weight in a reduced-calorie, partially-frozen mix, syrup, or beverage.

In yet another embodiment, betaine is used as another non-caloric secondary freezing point depressant. Betaine, which may also be referred to as trimethylglycine, and which should not be confused with the more general class of all alkyl betaine surfactants, may be included along with L-hexose monosaccharide and/or L-pentose monosaccharide in a reduced-calorie, partially-frozen beverage. In some embodiments, betaine may be included at about 0.1% to about 0.5%, or about 0.4% to about 1.0%, or about 0.8 to about 1.5%, or about 1.4% to about 2.0%, or about 1.8% to about 2.0% weight of a finished beverage.

In yet another embodiment, D-tagatose is used as another non-caloric secondary freezing point depressant. In some embodiments, D-tagatose may be included at about 0.1% to about 0.5%, or about 0.4% to about 1.0% weight of a finished beverage.

Other non-caloric secondary freezing point depressants may include salts or acids at a level that does not adversely interfere with the taste and quality of the resultant beverage. Appropriate salts include, but are not limited to, sodium chloride, potassium chloride, sodium gluconate or potassium gluconate. Other appropriate salts will be readily apparent to the skilled artisan. Preferred salts are those such as sodium gluconate or potassium gluconate, which have less taste and therefore result in freezing point depression with less of an impact on the taste of the partially-frozen beverage.

The reader should also appreciate that the partially-frozen beverage according to the present disclosure may further include additives that may be included as ingredients in other foods or beverages. Such ingredients may include, for example, preservatives.

In some embodiments of this disclosure, the partially-frozen beverage mix or syrup may also include a foaming agent, such as yucca schidigera extracts, quillaia extracts, one or more other foaming agents, or mixtures thereof. A mix including a foaming agent may be configured to provide a substantial volume over-run, such as about 70% to about 120% or some other percentage, upon production of a partially-frozen beverage. For example, with a volume overrun of about 100%, 1 ounce of a mix will result in the production of 2 ounces of partially-frozen beverage.

In some embodiments, the partially-frozen beverage may include one or more sweeteners, in addition to the L-sugar. Sweeteners used in some embodiments may include high-potency sweeteners, natural-caloric sweeteners, nutritive-sweeteners, and combinations thereof. In some embodiments, a partially-frozen, reduced-calorie beverage may include L-hexose monosaccharides and a combination of sweeteners selected from the group of sucralose, acesulfame-potassium, and a one or more sugar alcohols, such as erythritol. Sucralose and acesulfame-potassium are high-intensity sweeteners that are much sweeter than caloric sweeteners. In some embodiments, sucralose may be present in a reduced-calorie partially frozen beverage at between about 5 ppm and about 400 ppm, and, more preferably, between about 50 ppm and about 200 ppm. Acesulfame potassium may, in some embodiments, be present in a reduced-calorie partially frozen beverage at between about 10 ppm and about 250 ppm, or more preferably between about 50 ppm and about 200 ppm.

In some embodiments, a combination of non-caloric sweeteners and caloric sweeteners may also be added to optimize the sweetness in a partially-frozen beverage. In these embodiments, it may be desirable to optimize the sweetness resulting from the reduction in caloric sweeteners, such as sucrose or HFCS.

Without being limited to a particular sweetener, representative categories and examples include:
(a) water-soluble sweetening agents such as dihydrochalcones, monellin, stevia glycosides and minor constituents of stevia glycosides, glycyrrhizin, dihydroflavenol, dihydroflavonol, and sugar alcohols such as sorbitol, mannitol, maltitol, and L-aminodicarboxylic acid aminoalkenoic acid ester amides, such as those disclosed in U.S. Pat. No. 4,619,834 of Zanno et al., and mixtures thereof,
(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof,
(c) dipeptide based sweeteners, such as L-aspartic acid derived sweeteners, such as L-aspartyl-L-phenylalanine methyl ester (Aspartame) and materials described in U.S. Pat. No. 3,492,131 of Schlatter, L-alpha-aspartyl-N-(2,2,4,4-tetramethyl-3-thietanyl)-D-alaninamide hydrate (Alitame), N—[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof,
(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideo-x y-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;
(e) protein based sweeteners such as thaumaoccous danielli (Thaumatin I and II); and
(f) the naturally occurring sweetener monatin (2-hydroxy-2-(indol-3-ylmethyl)-4-aminoglutaric acid) and its derivatives.

In some embodiments, a partially-frozen reduced-calorie beverage may further include one or more sweetener potentiators.

In some embodiments, exemplary sweetener potentiators may include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), and a combination comprising any of the foregoing potentiators.

In some embodiments, a partially-frozen reduced-calorie beverage may be a carbonated beverage, or FCB.

In some embodiments, a partially-frozen reduced-calorie beverage may include alcohol for the purpose of creating a reduced-calorie partially-frozen alcoholic beverage (e.g., frozen margarita). In one particular embodiment, a partially-frozen reduced-calorie beverage may include between about 1% to about 10% by weight of the finished beverage of ethyl alcohol.

In yet other embodiments, a partially-frozen reduced-calorie beverage may include an extract from coffee, or include coffee flavors, for the creation of a coffee-flavored partially-frozen beverage.

In some embodiments, the partially-frozen reduced-calorie beverage may include additives such as caffeine, coloring agents (“colorants” or “colorings”), emulsifiers, food-grade acids, minerals, micronutrients, plant extracts, preservatives, salts, including buffering salts, stabilizers, thickening agents, medicaments, and a combination comprising any of the foregoing. Those of ordinary skill in the art will understand that certain additives may meet the definition or function according to more than one of the above-listed additive categories.

Exemplary salts may include alkali or alkaline earth metal chlorides, glutamates, and the like. For example, monosodium glutamate, potassium chloride, sodium chloride, and a combination comprising any of the foregoing salts may be used. The salts may be added to the partially-frozen beverage as a flavor potentiator as described above. Food-grade acids for use in certain embodiments of the partially-frozen beverage may include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising any of the foregoing food-grade acids. The food-grade acid may be added as an acidulant to control the pH of the beverage, act as a preservative, or to enhance beverage stability. The pH of a partially-frozen beverage, syrup, mix, or concentrate may also be modified by the addition of food-grade compounds such as ammonium hydroxide, sodium carbonate, potassium carbonate, sodium bicarbonate, and the like, and a combination comprising any of the foregoing. Additionally, the pH may be adjusted by the addition of carbon dioxide. The pH may also affect the relative partition of solutes between liquid and solid portions of a beverage; such is particularly true if the pH is changed over a region where a solute becomes at least fractionally ionized. In some embodiments, the ionization of a component may be modified by selection of a pH that alters the fraction of a component which is ionized. In addition, a sweetener or bulk solute may in some cases be selected because within a desired pH range for a partially-frozen beverage, the component may exist in an ionized form.

A person having ordinary skill in the art will understand that embodiments of the disclosure may further comprise one or more flavor oils or flavors. Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents may include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent may include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents may include aldehydes and esters such as cinnamyl acetate, cinnamaldehyde, citral diethylacetal, dihydrocarvyl acetate, eugenyl formate, p methylamisol, and so forth. Examples of aldehyde flavorings may include acetaldehyde (apple), benzaldehyde (cherry, almond), anisic aldehyde (licorice, anise), cinnamic aldehyde (cinnamon), citral, i.e., alpha citral (lemon, lime), neral, i.e., beta citral (lemon, lime), decanal (orange, lemon), ethyl vanillin (vanilla, cream), heliotrope, i.e., piperonal (vanilla, cream), vanillin (vanilla, cream), alpha amyl cinnamaldehyde (spicy fruity flavors), butyraldehyde (butter, cheese), valeraldehyde (butter, cheese), citronellal (modifies, many types), decanal (citrus fruits), aldehyde C 8 (citrus fruits), aldehyde C 9 (citrus fruits), aldehyde C 12 (citrus fruits), 2 ethyl butyraldehyde (berry fruits), hexenal, i.e., trans 2 (berry fruits), tolyl aldehyde (cherry, almond), veratraldehyde (vanilla), 2,6 dimethyl 5 heptenal, i.e., melonal (melon), 2,6 dimethyloctanal (green fruit), and 2 dodecenal (citrus, mandarin), and the like.

The flavoring agents may be used in liquid or solid/dried form and may be used individually or in a mixture. When employed in dried form, suitable drying means, such as spray drying, may be used. Alternatively, the flavoring agent may be absorbed onto water-soluble materials, such as cellulose, starch, sugar, maltodextrin, gum arabic and so forth or may be encapsulated. In still other embodiments, the flavoring agent may be adsorbed onto silicas, zeolites, and the like. The techniques for preparing such dried forms are well-known to those skilled in the art.

In some embodiments, the flavoring agents may be used in many distinct physical forms. Without being limited thereto, such physical forms may include free forms, such as spray dried, powdered, beaded forms, encapsulated forms, emulsions such as caramel or gum arabic emulsions, and a combination comprising at least one of the foregoing physical forms. The particular amount of the flavoring agent effective for imparting flavor characteristics to the composition may depend upon several factors including the flavor, the flavor impression, and the like.

In some embodiments, the tartness of a beverage may be varied by selecting and combining acids to provide a desired tartness perception. Some factors to consider in determining a desired tartness include, for example, the acid's dissociation constant, solubility, and pH. These variables may be measured by measuring the titratable acidity of a partially-frozen beverage, syrup, mix, or concentrate.

In some embodiments, a coloring agent may be used in amounts effective to produce a desired color for the composition. Exemplary coloring agents may include pigments, natural food colors and dyes suitable for food, drug and cosmetic applications. A full recitation of all colorants approved by the United States Food and Drug Administration, together with corresponding chemical structures, may be found in the Kirk-Othmer Encyclopedia of Chemical Technology, 3rd Edition, in volume 5 at pages 857-884, which text is incorporated herein by reference.

As classified by the United States Food, Drug, and Cosmetic Act (21 C.F.R. 73), colors may include those exempt from certification colors (sometimes referred to as natural even though they can be synthetically manufactured) and certified colors (sometimes referred to as artificial), and a combination comprising any of the foregoing. In some embodiments, exemplary colors exempt from certification or natural colors may include, for example, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising any of the foregoing.

In some embodiments, exemplary certified colors may include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising any of the foregoing. In some embodiments, certified colors may include FD&C aluminum lakes, which consist of the aluminum salts of FD&C dyes extended on an insoluble substrate of alumina hydrate. Additionally, in some embodiments, certified colors may be included as calcium salts.

In some embodiments, a partially-frozen beverage may include additional preservatives to provide freshness and to prevent the unwanted growth of bacteria, molds, fungi, or yeast. The addition of a preservative, including antioxidants, may also be used to maintain the composition's color, flavor, or texture. Exemplary preservatives may include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising any of the foregoing preservatives.

### EXAMPLES

The examples that follow are intended as illustrations of embodiments of the beverages described herein. The reader should understand that these particular beverage formulations are described in an exemplary manner only.

The Freezing Point Depression for water is calculated with the following equation:

ΔT=K_{F}bi

wherein ΔT is the change in freezing point temperature, K_{F} is the molal freezing point depression constant, which is equal to 1.86° C.·kg/mole, b is the molal concentration of solute in water, and i is the van't Hoff Factor, which is the number of ion particles per individual molecule of solute. For non-ionic molecules, such as L-glucose, sucrose, and HFCS, i equals 1. To achieve an equivalent Freezing Point Depression, thereby keeping ΔT constant, the molal concentration (b) of the freezing point depressant in the reduced-calorie beverage (e.g., L-glucose) must equal the molal concentration (b) of the freezing point depressant in the full-calorie beverage (e.g., sucrose).

### Example 1

In the following Example 1, which is summarized in Table 1, a full-calorie sucrose-sweetened FCB with 12% sucrose by weight of the finished beverage is converted to an equivalent zero-calorie (or near-zero calorie) FCB by replacing the sucrose with L-glucose. In this example, all ingredients are held constant in concentration except for the sucrose and L-glucose. As discussed above, the molal concentration of the L-glucose in the reduced-calorie version must equal the molal concentration of sucrose in the original, full-calorie formulation. Since the molecular weight of sucrose is 342 grams per mole and the sucrose concentration in the original beverage was 12% by weight of the finished beverage, or about 29 grams of sucrose per 8 ounces of finished beverage (29 grams is about 12% of 240 grams, which is the weight of beverage in 8 ounces), then the original beverage contained approximately 0.0847 moles of sucrose (29 grams divided by 342 grams/mole). To achieve the same freezing point depression, the L-glucose must have 0.0847 moles, as well. Therefore, to achieve the same freezing point depression as the FCB with 12% sucrose, 0.0847 moles of L-glucose must be used. The molecular weight of L-glucose is 180 grams per mole, thus requiring 15.3 grams of L-glucose per 8 ounces of finished beverage (240 grams), or approximately 6.3% by weight of the finished beverage.

Further, there exists about 4 calories per 1 gram of sucrose. An 8 ounce serving is equal to about 240 grams of beverage. The full calorie beverage of this example includes about 29 grams of sucrose per 8 ounces of finished beverage, or 116 calories. As L-glucose has about zero calories per gram, the resulting FCB in this reduced-calorie FCB has about zero calories per 8 ounces of finished beverage.

TABLE 1

| | Full- | Reduced- |
|---|---|---|
| | Calorie FCB | Calorie FCB |
| Water | 8 ounces (240 grams) | 8 ounces (240 grams) |
| Sucrose % weight | 12% by weight, or 29 | 0.0% |
| in finished beverage | grams per 240 grams | |
| | of finished beverage | |
| Moles of sucrose | .0847 moles | .000 moles |
| Moles of sucrose | .353 moles/kg of | .000 moles/kg of |
| per kg of water | water | water |
| L-Glucose % weight | 0.0% | 6.3% by weight, or |
| in finished beverage | | 15.3 grams per 240 |
| | | grams of finished |
| | | beverage |
| Moles of L-Glucose | 0.0 moles | .0847 moles |
| Moles of L-Glucose | 0.0 moles/kg of | .353 moles/kg of |
| per kg of water | water | water |
| Calories per 8 ounces | 116 | <5 |

### Example 2

In the following Example 2, which is summarized in Table 2, a full-calorie sucrose-sweetened FCB with 12% sucrose by weight of the finished beverage is converted to an equivalent reduced-calorie FCB by replacing one half of the sucrose with L-glucose. In this example, all ingredients are held constant in concentration except for the sucrose and L-glucose. The molal concentration of the L-glucose in the reduced-calorie beverage must equal the molal concentration of sucrose in the full-calorie beverage that was replaced in the original formulation. Since the molecular weight of sucrose is 342 grams per mole and the sucrose concentration in the original beverage was 12% by weight of the finished beverage, or 29 grams of sucrose for 240 grams of finished beverage (8 ounces of beverage weighs about 240 grams), then the original beverage contained approximately 0.0847 moles of sucrose (29 grams divided by 342 grams/mole). To achieve the same freezing point depression by replacing 50% of the sucrose with L-glucose, the L-glucose must have a total concentration of 0.042 (50% of 0.0847) moles. Therefore, to achieve the same freezing point depression by removing one half of the sucrose from the FCB with 12% sucrose, 0.042 moles of L-glucose must be used. The molecular weight of L-glucose is 180 grams per mole, thus requiring about 7.6 grams of L-glucose per 8 ounces of finished beverage (240 grams of water), which is approximately 3.2% by weight of the finished beverage.

Further, there exists about 4 calories per 1 gram of sucrose. The full calorie beverage of this example includes about 29 grams of sucrose per 8 ounces of finished beverage, or 116 calories. L-glucose has about zero calories per gram. The resulting caloric content in the reduced-calorie FCB is about 58 calories per 8 ounces of finished beverage, as it contains about 14.5 grams of sucrose.

TABLE 2

| | Full- | Reduced- |
|---|---|---|
| | Calorie FCB | Calorie FCB |
| Water | 8 ounces (240 grams) | 8 ounces (240 grams) |
| Sucrose % weight | 12% by weight, or 29 | 6% by weight, or 14.5 |
| in finished beverage | grams per 240 grams | grams per 8 ounces |
| | of finished beverage | (240 grams) of |
| | | finished beverage |
| Moles of sucrose in | .0847 moles | .0424 moles |
| 8 ounces of beverage | | |
| Moles of sucrose | .353 moles/kg of | .176 moles/kg of |
| per kg of water | water | water |
| L-Glucose % weight | 0.0% | 3.2% by weight, or 7.6 |
| in finished beverage | | grams per 240 grams |
| | | of finished beverage |
| Moles of L-Glucose in | 0.0 moles | .0424 moles |
| 8 ounces of beverage | | |
| Moles of L-Glucose | 0.0 moles/kg of | .176 moles/kg of |
| per kg of water | water | water |
| Calories per 8 ounces | 116 | 58 |

### Example 3

In the following Example 3, which is summarized in Table 3, a full-calorie D-glucose-sweetened FCB with 10% D-glucose by weight of the finished beverage is converted to an equivalent zero-calorie FCB by replacing the D-glucose with L-glucose. In this example, all ingredients are held constant in concentration except for the D-glucose and L-glucose. The molal concentration of the L-glucose in the reduced-calorie beverage must equal the molal concentration of D-glucose in the full-calorie beverage. Since the molecular weight of D-glucose is 180 grams per mole and the D-glucose concentration in the original beverage was 10% by weight of the finished beverage, or 24 grams of D-glucose for 240 grams of finished beverage (8 ounces of beverage weighs about 240 grams), then the original beverage contained approximately 0.133 moles of D-glucose (24 grams divided by 180 grams/mole). To achieve the same freezing point depression by replacing the D-glucose with L-glucose, the L-glucose must have a total molal concentration of 0.133 moles for 8 ounces of finished beverage. Therefore, to achieve the same freezing point depression as the FCB with 10% D-glucose, 0.133 moles of L-glucose must be used. The molecular weight of L-glucose is also 180 grams per mole, thus requiring about 24 grams of L-glucose per 8 ounces of finished beverage (240 grams of water), which is approximately 10% by weight of the finished beverage.

Further, there exists about 4 calories per 1 gram of HFCS. The full calorie beverage of this example includes about 24 grams of HFCS per 8 ounces of finished beverage, or 96 calories. L-glucose has about zero calories per gram. The resulting caloric content in the reduced-calorie FCB is about 0 calories per 8 ounces of finished beverage.

TABLE 3

| | Full- | Reduced- |
|---|---|---|
| | Calorie FCB | Calorie FCB |
| Water | 8 ounces (240 grams) | 8 ounces (240 grams) |
| D-Glucose % weight | 10% by weight, or 24 | 0.0% |
| in finished beverage | grams per 240 grams | |
| | of finished beverage | |
| Moles of D-Glucose in | .1333 moles | 0.0 moles |
| 8 ounces of beverage | | |
| Moles of D-Glucose | .5555 moles/kg of | 0.0 moles/kg of |
| per kg of water | water | water |
| L-Glucose % weight | 0.0% | 10% by weight, or 24 |
| in finished beverage | | grams per 240 grams |
| | | of finished beverage |
| Moles of L-Glucose in | 0.0 moles | .1333 moles |
| 8 ounces of beverage | | |
| Moles of L-Glucose | 0.0 moles/kg of | .5555 moles/kg of |
| per kg of water | water | water |
| Calories per 8 oz | 96 | <5 |

### Example 4

In the following Example 4, which is summarized in Table 4, a full-calorie D-glucose-sweetened FCB with 10% D-glucose by weight of the finished beverage is converted to an equivalent reduced-calorie FCB by replacing one-half of the D-glucose with L-glucose. In this example, all ingredients are held constant in concentration except for the D-glucose and L-glucose. The molal concentration of the L-glucose in the reduced-calorie beverage must equal one-half of the molal concentration of D-glucose in the full-calorie beverage. Since the molecular weight of D-glucose is 180 grams per mole and the D-glucose concentration in the original beverage was 10% by weight of the finished beverage, or 24 grams of D-glucose for 240 grams of finished beverage (8 ounces of beverage weighs about 240 grams), then the original beverage contained approximately 0.133 moles of D-glucose (24 grams divided by 180 grams/mole). To achieve the same freezing point depression by replacing one half of the D-glucose with L-glucose, the L-glucose must have a total molal concentration of 0.0667 (50% of 0.1333) moles for 8 ounces of finished beverage. Therefore, to achieve the same freezing point depression as the FCB with 10% D-glucose by replacing one-half of the D-glucose with L-glucose, 0.0667 moles of L-glucose must be used. The molecular weight of L-glucose is also 180 grams per mole, thus requiring about 12 grams of L-glucose per 8 ounces of finished beverage (240 grams of water), which is approximately 5% by weight of the finished beverage.

Further, there exists about 4 calories per 1 gram of HFCS. The full calorie beverage of this example includes about 24 grams of D-glucose per 8 ounces of finished beverage, or 96 calories. L-glucose has about zero calories per gram. As the reduced-calorie FCB still has about 12 grams of D-glucose, the resulting caloric content in the reduced-calorie FCB is about 48 calories per 8 ounces of finished beverage.

TABLE 4

| | Full- | Reduced- |
|---|---|---|
| | Calorie FCB | Calorie FCB |
| Water | 8 ounces (240 grams) | 8 ounces (240 grams) |
| D-Glucose % weight | 10% by weight, or 24 | 5% by weight, or 12 |
| in finished beverage | grams per 240 grams | grams per 240 grams |
| | of finished beverage | of finished beverage |
| Moles of D-Glucose in | .1333 moles | 0.0667 moles |
| 8 ounces of beverage | | |
| Moles of D-Glucose | .5555 moles/kg of | 0.2778 moles/kg of |
| per kg of water | water | water |
| L-Glucose % weight | 0.0% | 5% by weight, or 12 |
| in finished beverage | | grams per 240 grams |
| | | of finished beverage |
| Moles of L-Glucose in | 0.0 moles | 0.0667 moles |
| 8 ounces of beverage | | |
| Moles of L-Glucose | 0.0 moles/kg of | 0.2778 moles/kg of |
| per kg of water | water | water |
| Calories per 8 oz | 96 | 48 |

### Example 5

In the following Example 5, which is summarized in Table 5, a full-calorie D-glucose-sweetened FCB with 10% D-glucose by weight of the finished beverage is converted to an equivalent reduced-calorie FCB by replacing the D-glucose with about 4.6% by weight L-glucose and 3.5% by weight erythritol. In this example, all ingredients are held constant in concentration except for the D-glucose, L-glucose, and erythritol.

To achieve the same level of freezing point depression, the molal concentration of the L-glucose and erythritol in the reduced-calorie version must equal the molal concentration of D-glucose that was replaced in the original formulation. Since the molecular weight of D-glucose is 180 grams per mole and the D-glucose concentration in the original beverage was 10% by weight of the finished beverage, or 24 grams of D-glucose for 240 grams of finished beverage (8 ounces of beverage weighs about 240 grams), then the original beverage contained approximately 0.13 moles of D-glucose (24 grams divided by 180 grams/mole). To achieve the same freezing point depression by replacing the D-glucose with L-glucose and erythritol, the L-glucose and erythritol must combine to have a total molal concentration of 0.13 moles for 8 ounces of finished beverage.

Using 3.5% erythritol by weight of the finished beverage will result in approximately 8.4 grams of erythritol for 8 ounces of beverage. The molecular weight of erythritol is 122 grams/mole, therefore, about 0.07 moles of erythritol per 8 ounces of beverage is used. (8.4 grams÷122 grams/mole).

Since 0.07 moles of erythritol is used, about 0.06 moles of L-glucose must be used, as 0.13 moles of D-glucose from the original full-calorie formulation must be replaced. As the molecular weight of L-glucose is 180 grams/mole, 0.06 moles of L-glucose weighs about 11 grams. In an 8 ounce beverage, 11 grams is approximately 4.6% weight of the finished beverage.

Therefore, to achieve the same freezing point depression as the FCB with 10% D-glucose, the D-glucose is replaced with 3.5% by weight erythritol and 4.6% by weight L-glucose.

Further, there exists about 4 calories per 1 gram of HFCS. The full calorie beverage of this example includes about 24 grams of D-glucose per 8 ounces of finished beverage, or 96 calories. L-glucose and erythritol have about zero calories per gram.

TABLE 5

| | Full- | Reduced- |
|---|---|---|
| | Calorie FCB | Calorie FCB |
| Water | 8 ounces (240 grams) | 8 ounces (240 grams) |
| D-Glucose % weight | 10% by weight, or 24 | 0.0% |
| in finished beverage | grams per 240 grams | |
| | of finished beverage | |
| Moles of D-Glucose in | .13 moles | 0.0 moles |
| 8 ounces of beverage | | |
| Moles of D-Glucose | .55 moles/kg of | 0.0 moles/kg of |
| per kg of water | water | water |
| L-Glucose % weight | 0.0% | 4.6% by weight, or 11 |
| in finished beverage | | grams per 240 grams |
| | | of finished beverage |
| Moles of L-Glucose in | 0.0 moles | 0.06 moles |
| 8 ounces of beverage | | |
| Moles of L-Glucose | 0.0 moles/kg of | 0.25 moles/kg of |
| per kg of water | water | water |
| Erythritol % weight | 0.0% | 3.5%, or 8.4 grams per |
| in finished beverage | | 240 grams of finished |
| | | beverage |
| Moles of Erythritol in | 0.0 moles | 0.07 moles |
| 8 ounces of beverage | | |
| Moles of Erythritol | 0.0 moles/kg of | 0.29 moles/kg of |
| per kg of water | water | water |
| Calories per 8 oz | 96 | <5 |

### Example 6

In the following Example 6, which is summarized in Table 6, a full-calorie D-glucose-sweetened FCB with 10% D-glucose by weight of the finished beverage is converted to an equivalent reduced-calorie FCB by replacing the D-glucose with about 3.7% by weight L-glucose, 3.5% by weight erythritol, and 1.0% by weight D-tagatose. In this example, all ingredients are held constant in concentration except for the D-glucose, L-glucose, D-tagatose, and erythritol.

To achieve the same level of freezing point depression, the molal concentration of the L-glucose, erythritol, and D-tagatose in the reduced-calorie version must equal the molal concentration of D-glucose within the original formulation. Since the molecular weight of D-glucose is 180 grams per mole and the D-glucose concentration in the original formulation is 10% by weight of the finished beverage, or 24 grams of D-glucose for 240 grams of finished beverage (8 ounces of beverage weighs about 240 grams), then the original beverage contained approximately 0.13 moles of D-glucose (24 grams divided by 180 grams/mole). To achieve the same freezing point depression by replacing the D-glucose with L-glucose, erythritol, and D-tagatose, the L-glucose, erythritol, and D-tagatose must combine to have a total molal concentration of 0.13 moles for 8 ounces of finished beverage.

Using 3.5% erythritol by weight of the finished beverage will result in approximately 8.4 grams of erythritol for 8 ounces of beverage. The molecular weight of erythritol is 122 grams/mole, therefore, about 0.07 moles of erythritol per 8 ounces of beverage is used. (8.4 grams÷122 grams/mole).

Using 1.0% D-tagatose by weight of the finished beverage will result in approximately 2.4 grams of D-tagatose for 8 ounces of beverage. The molecular weight of D-tagatose is 180 grams/mole, therefore, about 0.01 moles of D-tagatose per 8 ounces of beverage is used.

Since 0.07 moles of erythritol and 0.01 moles of D-tagatose are used, about 0.05 moles of L-glucose must be used, as 0.13 moles of D-glucose from the original full-calorie formulation must be replaced. As the molecular weight of L-glucose is 180 grams/mole, 0.05 moles of L-glucose weighs about 9 grams. In an 8 ounce beverage, 9 grams is approximately 3.7% weight of the finished beverage.

Therefore, to achieve the same freezing point depression as the FCB with 10% by weight D-glucose, the D-glucose is replaced with 3.5% by weight erythritol, 3.7% by weight L-glucose, and 1.0% by weight D-tagatose.

Further, there exists about 4 calories per 1 gram of HFCS. The full calorie beverage of this example includes about 24 grams of D-glucose per 8 ounces of finished beverage, or 96 calories. L-glucose, D-tagatose, and erythritol have about zero calories per gram.

TABLE 6

| | Full- | Reduced- |
|---|---|---|
| | Calorie FCB | Calorie FCB |
| Water | 8 ounces (240 grams) | 8 ounces (240 grams) |
| D-glucose % weight | 10% by weight, or 24 | 0.0% |
| in finished beverage | grams per 240 grams | |
| | of finished beverage | |
| Moles of D-glucose | .13 moles | 0.0 moles |
| in 8 ounces of beverage | | |
| Moles of D-glucose | .55 moles/kg of | 0.0 moles/kg of |
| per kg of water | water | water |
| L-Glucose % weight | 0.0% | 3.7% by weight, or 9 |
| in finished beverage | | grams per 240 grams |
| | | of finished beverage |
| Moles of L-Glucose in | 0.0 moles | 0.05 moles |
| 8 ounces of beverage | | |
| Moles of L-Glucose | 0.0 moles/kg of | 0.21 moles/kg of |
| per kg of water | water | water |
| Erythritol % weight | 0.0% | 3.5%, or 8.4 grams per |
| in finished beverage | | 240 grams of finished |
| | | beverage |
| Moles of Erythritol in | 0.0 moles | 0.07 moles |
| 8 ounces of beverage | | |
| Moles of Erythritol | 0.0 moles/kg of | 0.29 moles/kg of |
| per kg of water | water | water |
| D-Tagatose % weight | 0.0% | 1.0%, or 2.4 grams per |
| in finished beverage | | 240 grams of finished |
| | | beverage |
| Moles of D-Tagatose in | 0.0 moles | 0.01 moles |
| 8 ounces of beverage | | |
| Moles of D-Tagatose | 0.0 moles/kg of | 0.06 moles/kg of |
| per kg of water | water | water |
| Calories per 8 oz | 96 | <5 |

The reader should appreciate that the above examples do not take sucrose equivalency into account. Natural and/or artificial high-intensity sweeteners used alone or in combination could be used to match the sweetness of a full-calorie product. S. S. Schiffman, C. A. Gatlin, Sweeteners: State of Knowledge Review, Neuroscience & Biobehavioral Reviews, Volume 17, Issue 3, Pages 313-345 (1993) discusses sweetness potency as it relates to high intensity sweeteners. Susan S. Schiffman, Elizabeth A. Sattely-Miller, Brevick G. Graham, Barbara J. Booth, and Kernon M. Gibes, Synergism Among Ternary Mixtures of Fourteen Sweeteners, Oxford Journals—Chemical Senses, Volume 25, Issue 2, Pates 131-140 (1999) discusses synergy of sweeteners as it relates to mixtures of sweeteners.

While many examples in this document refer to partially-frozen, reduced-calorie beverages, mixes, syrups, or concentrates, it is understood that those compositions are described in an exemplary manner only and that other compositions may be used, such as for non-partially-frozen foods and beverages comprising L-sugar, such as L-hexose monosaccharide and L-pentose monosaccharide as reduced-calorie sweeteners. Some examples of these other foods and beverages include soft drinks, such as carbonated soft drinks, juices, teas, and applesauce, for example. Additionally, other ingredients may be used, depending on the particular needs. Although the foregoing specific details describe certain embodiments, persons of ordinary skill in the art will recognize that various changes may be made in the details of these embodiments without departing from the spirit and scope of this disclosure as defined in the appended claims and considering the doctrine of equivalents. Therefore, it should be understood that this disclosure is not limited to the specific details shown and described herein.

We claim:

1. A partially-frozen beverage comprising:
water;
flavoring; and
L-glucose in a concentration of about 0.1% to about 10% of the finished weight of the beverage,
wherein the L-glucose depresses the freezing point of the partially-frozen beverage to render the beverage as a slush.

2. The partially-frozen beverage of claim 1, wherein the partially-frozen beverage further comprises carbon dioxide, and the partially-frozen beverage is a frozen carbonated beverage.

3. The partially-frozen beverage of claim 1, wherein the partially-frozen beverage further comprises a sugar selected from the group consisting of HFCS, sucrose, D-glucose, and D-fructose.

4. The partially-frozen beverage of claim 3, wherein the sugar is HFCS with a molal concentration of at least about 0.27 moles per kilogram of water.

5. The partially-frozen beverage of claim 3, wherein the sugar is sucrose with a molal concentration of at least about 0.17 moles per kilogram of water.

6. The partially-frozen beverage of claim 1, wherein the L-glucose has a molal concentration of at least about 0.35 moles per kilogram of water.

7. The partially-frozen beverage of claim 1, wherein the L-glucose is added in a concentration of between about 3% to about 5% by weight of the finished beverage.

8. The partially-frozen beverage of claim 1, wherein the beverage further comprises a high-intensity sweetener selected from the group consisting of aspartame, saccharin, acesulfame-K, stevia glycosides, minor constituents of stevia glycosides, cyclamate, Lo Han Guo, and sucralose

9. The partially-frozen beverage of claim 8, wherein the concentration of the high-intensity sweetener is between about 5 ppm to about 400 ppm.

10. The partially-frozen beverage of claim 1, wherein the beverage further comprises ethyl alcohol in a concentration between about 1% to about 10% by weight of the finished beverage.

11. The partially-frozen beverage of claim 1, wherein the beverage further comprises betaine in a concentration of between about 0.1% to about 2% by weight of the finished beverage.

12. The partially-frozen beverage of claim 1, wherein the beverage further comprises D-tagatose in a concentration of between about 0.1% to about 1.0% by weight of the finished beverage

13. The partially-frozen beverage of claim 7, wherein the L-glucose has a molal concentration of at least about 0.55 moles per kg of water.

14. The partially-frozen beverage of claim 1, wherein the partially-frozen beverage comprises a caloric concentration of less than 60 calories per 8 ounce serving of the finished beverage.

15. The partially-frozen beverage of claim 14, wherein the partially-frozen beverage comprises less than 5 calories per 8 ounce serving of the finished beverage.

16. The partially-frozen beverage of claim 1, wherein the beverage further comprises a secondary freezing point depressant selected from the group consisting of mineral salts, sugar alcohol, and acid.

17. The partially-frozen beverage of claim 1, wherein the partially-frozen beverage further comprises erythritol in a concentration of between about 0.1% to about 3.5% by weight of the finished beverage

18. The partially-frozen beverage of claim 17, wherein the beverage further comprises D-tagatose in a concentration of between about 0.1% to about 1.0% by weight of the finished beverage

19. A reduced-calorie beverage mix for use in a partially-frozen beverage dispensing machine, said beverage mix comprising:
flavors selected from the group consisting of natural flavors and artificial flavors; and
L-glucose in an amount sufficient to depress the freezing point of a finished beverage by at least 1° F. when said beverage mix is combined with water for subsequent use with the partially-frozen beverage dispensing machine.

20. A method for making a reduced-calorie partially-frozen beverage comprising the steps of:
(a) combining water, flavoring, and at least about 0.17 moles per kilogram of water of a primary freezing point depressant to form a reduced-calorie beverage syrup, wherein the primary freezing point depressant is selected from the group consisting of L-glucose, L-allose, L-fructose, L-gulose, L-galactose, L-altrose, L-idose, L-talose, L-tagatose, L-psicose, L-arabinose, L-lyxose, L-ribose, L-xylose, L-iribulose, and L-xylulose;
(b) loading the reduced-calorie beverage syrup into a frozen beverage dispensing machine;
(c) controlling a mixing chamber temperature of the frozen beverage dispensing machine to maintain the temperature of the beverage at or below 31° F.;
(d) partially-freezing the reduced-calorie beverage machine in the mixing chamber to form a partially-frozen beverage; and
(e) dispensing the partially-frozen beverage.

21. A pre-packaged reduced-calorie partially-frozen beverage comprising:
a flexible pouch;
water;
flavoring; and
L-glucose with a molal concentration of at least about 0.17 moles per kg of water,
wherein the water, flavoring, and L-glucose are mixed together and packaged in the flexible pouch.

22. A partially-frozen beverage comprising:
water;
flavoring; and
L-sugar in a concentration of about 3% to about 10% of the finished weight of the partially-frozen beverage,
wherein the L-sugar depresses the freezing point of the partially-frozen beverage to render the beverage as a slush.

23. A partially-frozen beverage comprising:
water;
flavoring;
L-glucose in a concentration of between about 0.1% to about 10% of the finished weight of the beverage;
D-tagatose in a concentration of between about 0.1% to about 1.0% of the finished weight of the beverage; and
erythritol in a concentration of between about 0.1% to about 3.5% of the finished weight of the beverage,
wherein the L-glucose, D-tagatose, and erythritol depress the freezing point of the partially-frozen beverage to render the beverage as a slush.
